(19) United States
(12) Patent Application Publication
(10) Pub. No.: US 2016/0207289 A1
(43) Pub. Date: Jul. 21, 2016

(54) GLASS LAMINATED ARTICLES AND LAYERED ARTICLES

(71) Applicant: CORNING INCORPORATED, Corning, NY (US)

(72) Inventors: David Francis Dawson-Elli, Dundee, NY (US); Steven Edward DeMartino, Painted Post, NY (US); Laura Lee Hluck, Painted Post, NY (US)

(21) Appl. No.: 15/085,718

(22) Filed: Mar. 30, 2016

Related U.S. Application Data
(63) Continuation of application No. 14/474,820, filed on Sep. 2, 2014.
Application No. 14/474,820 is a continuation of application No. 12/427,397, filed on Apr. 21, 2009.
Application No. 12/427,397 is a continuation of application No. 12/531,203, filed on Sep. 14, 2009, now abandoned.
(60) Provisional application No. 61/057,344, filed on May 30, 2008.
(60) Provisional application No. 61/057,344, filed on May 30, 2008.

(51) Int. Cl. B32B 17/10; B32B 38/00; B32B 37/14

(52) U.S. Cl. CPC B32B 17/101; B32B 17/10119; B32B 37/14; B32B 38/0004; B32B 2605/006

(57) ABSTRACT

Laminated articles and layered articles, for example, low alkali glass laminated articles and layered articles useful for, for example, electrochromic devices are described.

### CROSS REFERENCES TO RELATED APPLICATIONS

This patent application is a continuation of U.S. application Ser. No. 14/474,820 filed Sep. 2, 2014, which is a continuation of U.S. application Ser. No. 12/427,397, filed Apr. 21, 2009, which claims the benefit of priority to U.S. Provisional Patent Application 61/057,344 filed on May 30, 2008, and is a continuation of U.S. application Ser. No. 12/531,203, filed Sep. 14, 2009, which claims the benefit of priority under 35 U.S.C. §365 of International Patent Application PCT/US2009/003295, filed on May 29, 2009 designating the United States of America which claims the benefit of priority under 35 U.S.C. §119(e) of U.S. Provisional Application Ser. No. 61/057,344 filed on May 30, 2008.

### BACKGROUND

1. Field

Embodiments of the invention relate to laminated articles and layered articles and more particularly to low alkali glass laminated articles and layered articles useful for, for example, electrochromic devices.

2. Technical Background

The management of natural light is a consideration in architectural design, for example, how to maximize the view of the outside while ensuring that the interior of the building is comfortable for the occupants. For example, too much light can increase the heat and/or brightness inside the building. Windows which can be switched from transparent to varying degrees of tinted and back to transparent, for example, electrochromic windows, are being developed to minimize one or more disadvantages associated with increased glass usage, for example, heat gain and glare.

Windows for use, for example, in automobiles and in architecture must meet several safety codes and are subject to mechanical strength tests, for example, debris impact tests and post-breakage wind cycling. Windows can benefit from increased mechanical strength, for example, in order to withstand environmental conditions.

Functional materials for electrochromic, photochromic, thermochromic, and low-e type applications are typically applied to a thick soda lime glass substrate, which is laminated to a second thick soda lime glass substrate in order to meet the above mentioned safety codes. The substrates are often coated with a barrier layer in order to minimize alkali, for example, sodium diffusion from the substrate into the functional materials. However, any breaks in the barrier layer, for example, scratches can allow sodium or alkalis to enter the functional material, compromising the utility of the functional material. Defects in the soda lime glass, for example, bubbles, scratches, inclusions can also compromise the utility of the functional material.

Glass strength can depend on exposure temperatures, aspect ratio, plate size, stiffness and load duration. Laminated glass can be made with annealed, heat strengthened, and/or fully tempered for additional benefits, such as resistance to increased wind loading, increased impact resistance or resistance to thermal stress.

It would be advantageous to have laminated articles and layered articles in which alkali diffusion such as sodium diffusion can be minimized and where mechanical strength and/or clarity can be maximized.

### SUMMARY

Laminated articles and layered articles of the invention address one or more of the above-mentioned disadvantages of conventional laminated articles and layered articles and provide one or more of the following advantages: minimizing alkali diffusion, for example, sodium diffusion into the functional material from the glass, reduction of defects in the glass, increased clarity, and minimized weight.

One embodiment is an article comprising:
a glass layer having a coefficient of thermal expansion 50×10⁻⁷/° C. or less;
a functional material disposed on the glass layer;
a substrate comprising a glass, a polymer, or a combination thereof, and having a thickness greater than that of the glass layer; and
a laminate layer disposed between the substrate and either the glass layer or functional material.

Another embodiment is an article comprising:
a glass layer having a sodium oxide content of 10 percent by weight or less;
an electrochromic, a thermochromic, a photochromic, a low-e type, an actively defrosting, a transparent conductive oxide material, or a combinations thereof disposed on the glass layer;
a substrate comprising a glass, a polymer, or a combination thereof, and having a thickness greater than that of the glass layer; and
a laminate layer disposed between the substrate and either the glass layer or functional material.

Another embodiment is an article comprising:
a glass layer having a coefficient of thermal expansion 50×10⁻⁷/° C. or less;
an electrochromic material disposed on the glass layer; and
a protective layer disposed on a surface of the electrochromic material not in contact with the glass layer.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that both the foregoing general description and the following detailed description are merely exemplary of the invention, and are intended to provide an overview or framework for understanding the nature and character of the invention as it is claimed.

The accompanying drawings are included to provide a further understanding of the invention, and are incorporated in and constitute a part of this specification. The drawings illustrate one or more embodiment(s) of the invention and together with the description serve to explain the principles and operation of the invention.

### BRIEF DESCRIPTION OF THE DRAWINGS

The invention can be understood from the following detailed description either alone or together with the accompanying drawing figures.

FIG. 1 is a schematic of an article according to one embodiment.

FIG. 2 is a schematic of an article according to one embodiment.

FIG. 3 is a schematic of an article according to one embodiment.

### DETAILED DESCRIPTION

Reference will now be made in detail to various embodiments of the invention, examples of which are illustrated in the accompanying drawings. Wherever possible, the same reference numbers will be used throughout the drawings to refer to the same or like parts.

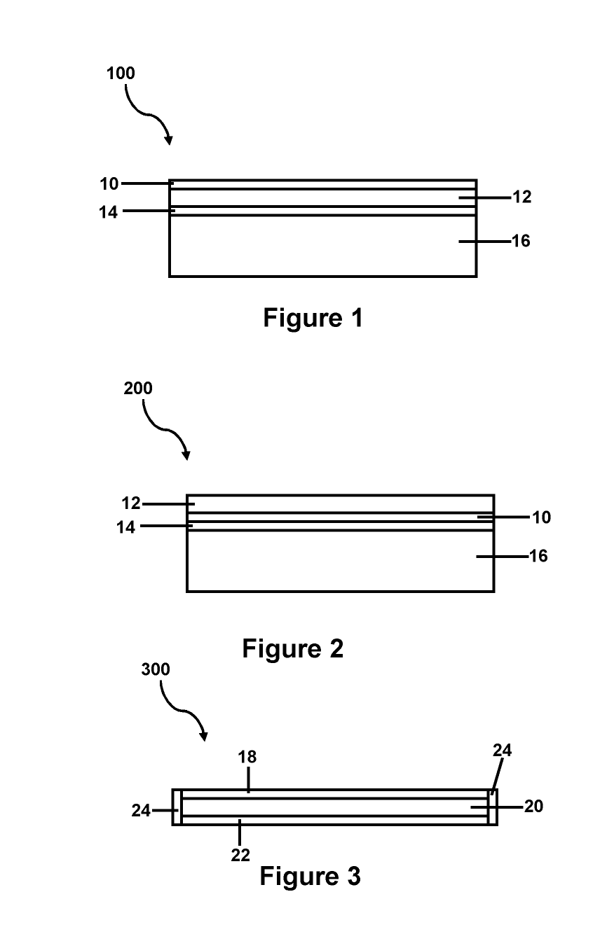

One embodiment, as shown in FIG. 1 and FIG. 2 is an article 100 and 200, respectively, comprising:
a glass layer 12 having a coefficient of thermal expansion 50×10⁻⁷/° C. or less;
a functional material 10 disposed on the glass layer;
a substrate 16 comprising a glass, a polymer, or a combination thereof, and having a thickness greater than that of the glass layer; and
a laminate layer 14 disposed between the substrate and either the glass layer or functional material.

Another embodiment, is an article comprising:
a glass layer having an alkali oxide content of 10 percent by weight or less;
an electrochromic, a thermochromic, a photochromic, a low-e type, an actively defrosting, a transparent conductive oxide material, or a combination thereof disposed on the glass layer;
a substrate comprising a glass, a polymer, or a combination thereof, and having a thickness greater than that of the glass layer; and
a laminate layer disposed between the substrate and either the glass layer or functional material.

Another embodiment is an article comprising:
a glass layer having a sodium oxide content of 10 percent by weight or less;
an electrochromic, a thermochromic, a photochromic, a low-e type, an actively defrosting, a transparent conductive oxide material, or a combination thereof disposed on the glass layer;
a substrate comprising a glass, a polymer, or a combination thereof, and having a thickness greater than that of the glass layer; and
a laminate layer disposed between the substrate and either the glass layer or functional material.

Another embodiment is an article comprising:
a glass layer having a coefficient of thermal expansion 50×10⁻⁷/° C. or less;
an electrochromic material disposed on the glass layer;
a substrate comprising a glass, a polymer, or a combination thereof, and having a thickness greater than that of the glass layer; and
a laminate layer disposed between the substrate and either the glass layer or functional material.

Another embodiment is an article comprising:
a transparent glass layer having an alkali oxide content of 10 percent by weight or less, wherein the transparent glass layer has thickness of from 0.5 mm to 4 mm;
an electrochromic material disposed on the transparent glass layer;
a substrate comprising a glass, a polymer, or a combination thereof, and having a thickness greater than that of the transparent glass layer; and
a laminate layer comprising a material selected from polyvinyl butyral, a UV curable resin, a thermoplastic, a thermoplastic ionoplast, polycarbonate, polyurethane, a UV curable polymer, silicone, and combinations thereof disposed between the substrate and either the transparent glass layer or functional material.

According to some embodiments, the glass layer has a thickness of 4.0 mm or less, for example, 3.5 mm or less, for example, 3.2 mm or less, for example, 3.0 mm or less, for example, 2.5 mm or less, for example, 2.0 mm or less, for example, 1.9 mm or less, for example, 1.8 mm or less, for example, 1.5 mm or less, for example, 1.1 mm or less, for example, 0.5 mm to 2.0 mm, for example, 0.5 mm to 1.1 mm, for example, 0.7 mm to 1.1 mm. Although these are exemplary thicknesses, the glass layer can have a thickness of any numerical value including decimal places in the range of from 0.1 mm up to and including 4.0 mm.

The glass layer can have a relatively low coefficient of thermal expansion (CTE), for example, 50×10⁻⁷/° C. or less, for example, 35×10⁻⁷/° C. or less. According to one embodiment, the glass layer has a CTE of 20×10⁻⁷/° C. to 50×10⁻⁷/° C., for example, 20×10⁻⁷/° C. to 35×10⁻⁷/° C.

The glass layer, in some embodiments, is transparent.

In one embodiment, the laminate layer comprises a material selected from polyvinyl butyral, a UV curable resin, a thermoplastic, a thermoplastic ionoplast, polycarbonate, polyurethane, a UV curable polymer, silicone, and combinations thereof.

The substrate, according to one embodiment comprises a glass, a polymer, or a combination thereof. For instance, the substrate can comprise a material selected from float glass, fusion formable glass, soda lime glass, plastic, polycarbonate, and combinations thereof.

The electrochromic, thermochromic, photochromic, low-e type, actively defrosting, or transparent conductive oxide material can comprise a single layer or multiple layers. The electrochromic functional material can comprise multiple layers such as an electrode layer or layers, a counter electrode layer or layers, an ion conducting layer or layers. The layers, in some embodiments, can comprise solid inorganic materials.

The glass layer, according to one embodiment, comprises an alkali oxide content of 10 percent by weight or less, for example, 9 percent or less, for example, 8 percent or less, for example, 5 percent or less, for example, 0.5 percent or less. In one embodiment, the alkali oxide content is in the range of from 0.1 percent to 10 percent. Although these are exemplary alkali oxide contents, the glass layer can have alkali oxide contents of any numerical value including decimal places in the range of from 0 up to and including 10 percent by weight.

The glass layer, according to one embodiment, comprises a sodium oxide content of 10 percent by weight or less, for example, 9 percent or less, for example, 8 percent or less, for example, 5 percent or less, for example, 0.5 percent or less. In one embodiment, the sodium oxide content is in the range of from 0.1 percent to 10 percent by weight. Although these are exemplary sodium oxide contents, the glass layer can have sodium oxide contents of any numerical value including decimal places in the range of from 0 up to and including 10 percent by weight.

According to some embodiments, the configuration of the article can be, for example, those described by FIG. 1 and FIG. 2, however, other configurations can be used in accordance with the invention. For example, the laminate layer, can be disposed between the substrate and either the glass layer or functional material.

Another embodiment as shown in FIG. 3 is an article 300 comprising a glass layer 18 having a glass layer having a coefficient of thermal expansion 50×10⁻⁷/° C. or less; an electrochromic material 20 disposed on the glass layer; and a protective layer 22 disposed on a surface of the electrochromic material not in contact with the glass layer. The article, according to one embodiment, further comprises a seal material 24 joining the protective layer and the glass layer such that the combination of the protective layer, the glass layer, and the seal material together enclose the electrochromic material. The seal material can be selected from a frit, a glass sheet, and a sputtered glass. The seal material in combination with the protective layer and the glass layer can minimize deleterious effects of exposing the electrochromic material to the environment, for example, during shipping, manufacturing of a window, and/or in the final product such as a window in a building or in an automobile.

In this embodiment, the electrochromic material can comprise multiple layers such as an electrode layer or layers, a counter electrode layer or layers, an ion conducting layer or layers. The layers, in some embodiments, can comprise solid inorganic materials.

In this embodiment, the glass layer can have a thickness of 4.0 mm or less, for example, 3.5 mm or less, for example, 3.2 mm or less, for example, 3.0 mm or less, for example, 2.5 mm or less, for example, 2.0 mm or less, for example, 1.9 mm or less, for example, 1.8 mm or less, for example, 1.5 mm or less, for example, 1.1 mm or less, for example, 0.5 mm to 2.0 mm, for example, 0.5 mm to 1.1 mm, for example, 0.7 mm to 1.1 mm. Although these are exemplary thicknesses, the glass layer can have a thickness of any numerical value including decimal places in the range of from 0.1 mm up to and including 4.0 mm.

The glass layer can have a relatively low coefficient of thermal expansion (CTE), for example, 50×10⁻⁷/° C. or less, for example, 35×10⁻⁷/° C. or less. According to one embodiment, the glass layer has a CTE of 20×10⁻⁷/° C. to 50×10⁻⁷/° C., for example, 20×10⁻⁷/° C. to 35×10⁻⁷/° C.

The glass layer, in some embodiments, is transparent.

The protective layer can provide chemical or mechanical durability. The protective layer can be a sputtered glass layer or a sheet of glass, for example, a transparent glass layer or sheet. The protective layer, according to some embodiments, has a thickness of 4.0 mm or less, for example, 3.5 mm or less, for example, 3.2 mm or less, for example, 3.0 mm or less, for example, 2.5 mm or less, for example, 2.0 mm or less, for example, 1.9 mm or less, for example, 1.8 mm or less, for example, 1.5 mm or less, for example, 1.1 mm or less, for example, 0.5 mm to 2.0 mm, for example, 0.5 mm to 1.1 mm, for example, 0.7 mm to 1.1 mm. Although these are exemplary thicknesses, the protective layer can have a thickness of any numerical value including decimal places in the range of from 0.1 mm up to and including 4.0 mm.

The protective layer can have a relatively low coefficient of thermal expansion (CTE), for example, 50×10⁻⁷/° C. or less, for example, 35×10⁻⁷/° C. or less. According to one embodiment, the protective layer has a CTE of 20×10⁻⁷/° C. to 50×10⁻⁷/° C., for example, 20×10⁻⁷/° C. to 35×10⁻⁷/° C.

The protective layer, in some embodiments, is transparent.

In some embodiments, the electrochromic material can comprise multiple layers such as an electrode layer or layers, a counter electrode layer or layers, an ion conducting layer or layers. The layers, in some embodiments, can comprise solid inorganic materials.

Laminating thin, low CTE, low alkali glass coated with a functional material to thick soda lime glass enables process improvements and can minimize costs. Low CTE, low alkali glass is durable, has increased clarity as compared to soda lime glass, and can be made with minimal defects, for example, in display glass applications for televisions.

In architectural windows, commercially available windows are typically 6 mm thick. According to the present invention, 0.7 mm to 1.1 mm low CTE, low alkali glass can be laminated to a less than 6 mm soda lime glass using a polyvinyl butyral laminate by one of a number of laminating processes. The soda lime glass could be annealed, heat strengthened (HS) and/or fully tempered (FT) depending on the strength required to meet relevant transportation or building codes.

In this example, the soda lime glass provides a strength benefit in that it can be annealed, heat strengthened (typically 2× strength of annealed glass) and/or fully tempered (typically 4× strength of annealed glass) to provide additional mechanical strength that may be required by transportation or building codes. Low CTE low alkali glass is typically available only in annealed form, thus the substrate, in this example, the soda lime glass provides the increased strength of the laminated article.

The glass layer, according to the invention, provides one or more of the following advantages: low alkali glass reduces the need for a barrier layer on soda lime glass in order to minimize sodium/alkali diffusion; low alkali glass enhances the performance of organic or inorganic coating, for example, electrochromic, thermochromic, photochromic, low-e; low alkali glass can be processed at high temperatures; low alkali glass can be cut after coating. Thin low alkali glass is light weight and minimizes the cost associated with a low CTE, low alkali product.

Lamination can provide one or more of the following advantages safety, security, sound reduction, UV control, weather/natural disaster benefit, durability, design versatility, installation ease, and low visual distortion. Lamination can be used to laminate a thin, low alkali glass to various substrates. This can be useful in tailoring other properties, for instance, color or self-cleaning properties.

The laminated articles and layered articles of the invention can be used, for example, for electrochromic windows for general transportation (cars, trains, light rail, airplanes, buses), buildings (commercial and residential), and for PV cells both for buildings (commercial and residential), and on-off grid.

The laminated articles and layered articles can be incorporated as the outer, center or inner pane of a single pane, double pane, or triple pane window, for example.

It will be apparent to those skilled in the art that various modifications and variations can be made to the present invention without departing from the spirit or scope of the invention. Thus, it is intended that the present invention cover the modifications and variations of this invention provided they come within the scope of the appended claims and their equivalents.

What is claimed is:

1. An automotive window comprising:
a glass layer having:
a coefficient of thermal expansion 50×10⁻⁷/° C. or less;
an alkali oxide content of 10 percent by weight or less; and
a thickness of 2.5 mm or less;
a coating material disposed on the glass layer, the coating comprising any one or more of a low-e type, an actively defrosting, and a transparent conductive oxide material;
a substrate comprising a soda lime glass and having a thickness greater than that of the glass layer; and
a laminate layer disposed between the substrate and the glass layer.

2. The automotive window of claim 1, wherein the alkali oxide is sodium oxide.

3. The automotive window of claim 1, wherein the coefficient of thermal expansion is from 20×10⁻⁷/C to 50×10⁻⁷/° C.

4. The automotive window of claim 3, wherein the coefficient of thermal expansion is from 20×10⁻⁷/C to 35×10⁻⁷/° C.

5. The automotive window of claim 1, wherein the substrate comprises an annealed, heat strengthened, or fully tempered soda lime glass.

6. The automotive window of claim 5, wherein the substrate is about 6 mm thick.

7. The automotive window of claim 5, wherein the substrate is less than 6 mm thick.

8. The automotive window of claim 1, wherein the article does not comprise a barrier layer.

9. The automotive window of claim 1, further comprising a laminate layer comprising a material selected from polyvinyl butyral, a UV curable resin, a thermoplastic, a thermoplastic ionoplast, polycarbonate, polyurethane, a UV curable polymer, silicone, and combinations thereof disposed between the substrate and either the transparent glass layer or functional material.

10. An automobile comprising the automotive window of claim 1.

11. A method of making the automotive window of claim 1, comprising:
coating the glass layer with the coating material;
laminating the glass layer and substrate; and
cutting the glass layer after coating.

12. The method of claim 11, wherein the alkali oxide content is 5 percent by weight or less.

13. The method of claim 11, wherein the alkali oxide is sodium oxide.

14. The method of claim 11, wherein the coefficient of thermal expansion is from 20×10⁻⁷/C to 50×10⁻⁷/° C.

15. The method of claim 14, wherein the coefficient of thermal expansion is from 20×10⁻⁷/C to 35×10⁻⁷/° C.

16. The method of claim 11, wherein the substrate comprises an annealed, heat strengthened, or fully tempered soda lime glass.

17. The method of claim 16, wherein the substrate is about 6 mm thick.

18. The method of claim 16, wherein the substrate is less than 6 mm thick.

19. The method of claim 11, wherein the article does not comprise a barrier layer.

20. The method of claim 11, wherein the substrate and glass layer are laminated via a laminate layer comprising a material selected from polyvinyl butyral, a UV curable resin, a thermoplastic, a thermoplastic ionoplast, polycarbonate, polyurethane, a UV curable polymer, silicone, and combinations thereof disposed between the substrate and either the transparent glass layer or functional material.
